(19) United States
(12) Patent Application Publication
(10) Pub. No.: US 2011/0088919 A1
(43) Pub. Date: Apr. 21, 2011

(54) FIRE-EXTINGUISHING DEVICE FOR AN OIL STOVE

(76) Inventors: Chul Kim, Paju-si (KR); Jae hoon Kim, Gochang-eup (KR); Jae ho Kim, Bucheon-si, Gyeonggi-do (KR)

(21) Appl. No.: 12/997,607

(22) PCT Filed: Feb. 6, 2009
(86) PCT No.: PCT/KR2009/000580

§ 371 Date: Dec. 12, 2010

(30) Foreign Application Priority Data
Jun. 26, 2008 (KR) 10-2008-0060802

(51) Int. Cl. A62C 3/00

(52) U.S. Cl. 169/65

(57) ABSTRACT

The present invention relates to a device for rapidly extinguishing a fixed-wick oil stove by closing off an oil-supply tube when the oil stove is overturned or an earthquake occurs. More specifically, it relates to a device of this type which is formed using just a construction having no need for an electrical power source, which reduces costs, which entails no risk of breakdown, and which after the oil stove has been extinguished can straightforwardly be restored to the state prior to operation. The present invention is a fixed-wick oil burner which comprises: a hexahedral housing (40) provided on a support (10); a lever (50) which is supported in such a way as to be able to perform a seesaw movement on a floor plate (41b) of the housing (40), and which is provided with a resilient support member (53) between its under-surface at one end and the floor plate (41b), and which also has positioned, between its other end and the floor plate (41b), an oil-supply tube (22) formed of a heat-resistant flexible material; a weighting member (60) which is provided between an upper plate (41a) and one end of the lever (50) in such a way that a resilient member (61) is used to force face-to-face contact between facing parts, an upper weighting body (62a) and a lower weighting body (62b), and in such a way that the upper end of the upper weighting body (62a) and the lower end of the lower weighting body (62b) come into face-to-face contact with the upper plate (41a) and one end of the lever (50), and which is arranged in such a way that it gives way when a shock force of more than a certain value is transmitted to one or other of the upper and lower weighting bodies (62a) or (62b); and a restoring rod (70) which is connected to the lever (50), with a free end projecting outside the upper plate (41a).

### TECHNICAL FIELD

The present invention relates to a fire extinguishing device for an oil stove, in detail, a device for quickly extinguishing an oil stove by closing an oil supply tube supplying oil to a fixed-wick inserted in a wick tube when a fixed-wick type stove is turned upside down or an earthquake occurs.

### BACKGROUND ART

Oil stoves are equipped with an emergency extinguishing device to prevent a fire when the oil stoves are turned upside down or an earthquake occurs.

An example of the emergency extinguishing device for the oil stoves is disclosed in Patent Documents 1 and 2. A vibration attenuating device for stopping fluid fuel includes a main body having a fluid fuel channel, an elastic retainer disposed at the upper portion of the main body and having a plurality of hooks extending toward the center of the main body, a dropping body connected to the elastic retainer, a retaining-force adjuster adjusting retaining-force for the dropper, a valve movably disposed in the main body to open/close the fluid fuel channel and receiving elastic force to be closed, an elevating body fitted in the valve to be able to receive the dropping body and move up/down to close the fluid fuel channel by moving down in vibration, and a locking member locking the elevating member, such that the dropping body separates from the elastic retainer and drops and the elevating body moves down and the valve moves down, thereby closing the fluid fuel channel and extinguishing a burner.

Further, a heater for sensing impact disclosed in Patent Document 2 which includes a heater and a storage tank which are connected by a tube (fuel supply tube), in which a motor-equipped controller (stopping unit) controlling an opening/closing valve disposed in the fuel supply tube and an impact sensing unit are provided, such that when the impact sensing unit senses impact, the stopping unit is controlled by the output value to close the fuel supply tube, thereby stopping supplying fuel to the heater.

### [Patent Document 1]: JP 55-68527(A)

### [Patent Document 2]: KR 10-2005-0069841(A)

### DISCLOSURE

### Technical Problem

However, the vibration attenuating device for stopping fluid fuel disclosed in Patent Document 1 has a problem that the structure is complicated and the manufacturing cost is high, because a specific fluid fuel channel is disposed in the main body, the valve is disposed in the fluid fuel channel, and the locking member for the elevating member is provided. Further, the heater for sensing impact disclosed in Patent Document 2 has a problem that it cannot be used without power because the motor-equipped controller and the impact sensing unit need power, an expert is needed to fix the device, the structure of the controller and the impact sensing unit is complicated, and the manufacturing cost is high.

The present invention has been made to solve the problems and it is an object of the present invention to provide a fire-extinguishing device for an oil stove which makes it possible to reduce manufacturing cost without trouble by having a structure not requiring power, and can simply returns to the state before operation, after extinguishing the oil stove.

### Technical Solution

In order to achieve the object of the present invention, a fire-extinguishing device for an oil stove in which a wick tube with a wick therein is disposed at one side of a base, a burning tank is connected to the upper portion of the wick tube, and the wick tube and a fuel tank are connected by an oil supply tube, includes: a hexahedral housing disposed on the base; a lever pivotably supported by the bottom plate of the housing, with an elastic support between the bottom of one end and the bottom plate and the oil supply tube made of a heatproof material between the other end and the bottom plate; a weight formed by connecting an upper weight with a lower weight by using an elastic member such that the facing surfaces are in surface contact between the upper plate and one end of the lever, with the upper end of the upper plate and the lower end of the lower plate in surface contact with the upper plate and one end of the lever, in order to bend when shock force above a predetermined level is transmitted to any one of the upper and lower weights; and a return rod having the lower end connected to the lever such that the free end is exposed outside through the upper plate.

### ADVANTAGEOUS EFFECT

The present invention has a simple structure in which when shock force above a predetermined level is applied to an oil stove, the shock force is transmitted to any one of upper and lower weights, the joint and the upper end and the lower end of the upper and lower weights, respectively, bend, and the other end of a lever connected to the lower weight presses an oil supply tube, thereby extinguishing the oil stove. Therefore, the present invention can be used without possibility of trouble, for a long period of time even without power.

Further, it is possible to simply and quickly implement the state before operation only by pressing down a return rod lifted when the oil supply tube is closed. Therefore, the structure is simple and the manufacturing cost is reduced, without trouble.

### BRIEF DESCRIPTION OF DRAWINGS

FIG. 1 is a view showing installation of an embodiment of the present invention.

FIG. 2 is a partial-cut perspective view of an embodiment of the present invention.

FIG. 3 is an exploded perspective view of an exemplary embodiment of the present invention.

FIG. 4 is a cross-sectional view taken along the line A-A of FIG. 2.

FIG. 5 is a view showing a modified example of an embodiment of the present invention.

FIG. 6 is a view showing the operation of an embodiment of the present invention.

### BEST MODE

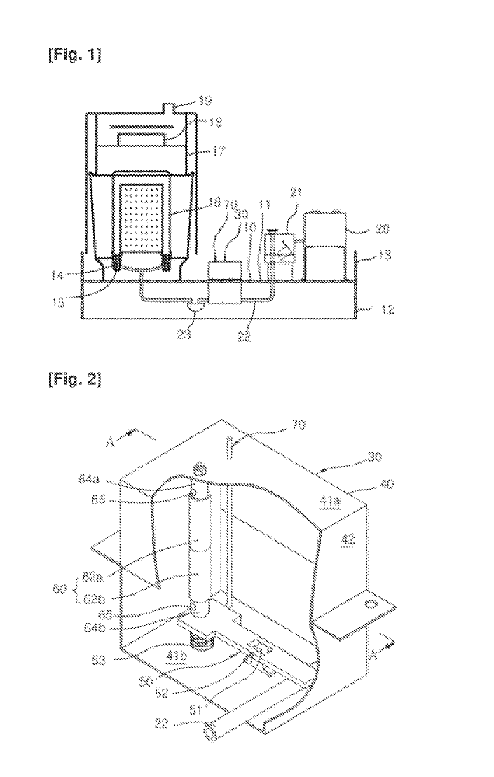

FIG. 1 is a view showing installation of an embodiment of the present invention, in which a reference numeral ‘10’ designates a base. The base 10 has a support wall 12 having a predetermined height under and around a base plate 11 formed in an elliptical shape and a protective plate 13 having a predetermined height at both sides of the base plate 11.

A reference numeral ‘14’ designates a wick tube disposed at a side of the base plate 11, a reference numeral ‘15’ designates a fixed-wick inserted in the wick tube 14, and a burning tank 16 is connected to the top of the wick tube 14.

Further, a heat dissipation plate 17 is disposed above the burning tank 16 and a re-burning net 18 is disposed inside the heat dissipation plate 17, such that flames produced in the burning tank 16 is re-burned at the re-burning net 18 and discharged to a stovepipe 19.

A reference numeral ‘20’ designates a fuel tank disposed at the other side of the base plate 11 and a reference numeral ‘21’ designates an oil supply controller disposed on the base plate 11. The fuel tank 20, the oil supply controller 21, and the wick tube 14 are connected by an oil supply tube 22, such that oil stored in the fuel tank 20 is controlled by the oil supply controller 21 and supplied at a predetermined height to the wick tube 14.

Further, a manual pump 23 is disposed between the oil supply controller 21 of the oil supply tube 22 and the wick tube 14 in order to make quick ignition by pressurizing the oil in the initial ignition such that the oil is quickly supplied to the wick tube 14.

Further, an extinguishing device 30 of the present invention is disposed in the oil supply tube 22 between the oil supply controller 21 on the base plate 11 and the manual pump 23.

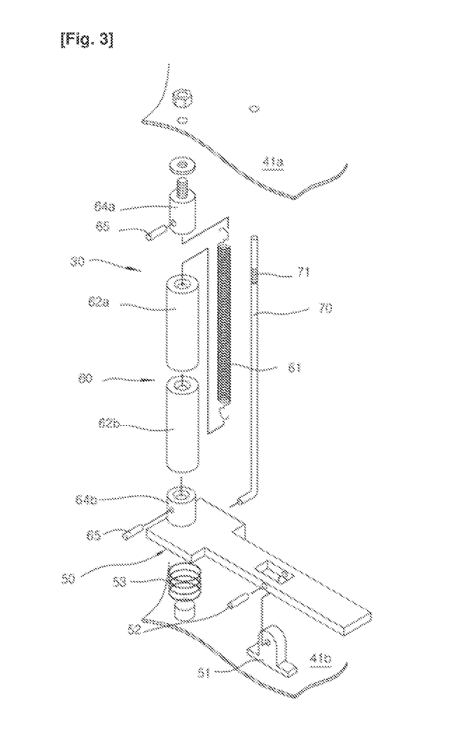

As shown in FIGS. 2 to 4, the extinguishing device 30 is largely composed of a housing 40, a lever 50, a weight 60, and a return rod 70.

The housing 40 is formed in a hexahedral shape with a top plate 41a, a bottom plate 41b, and side plates 42, where both lower sides of the side plates 42, that is, the both sides of the lower portion of the base plate 11 are open.

The lever 50 is supported by a support 51 on the bottom plate 41b to pivot about the center fixed by a pin 52, an elastic support 53, which is rubber or a coil spring, is disposed between the bottom of one end of the lever 50 and the bottom plate 41b, and the oil supply tube 22 made of a heatproof flexible material is disposed between the other end of the lever 50 and the bottom plate 41b.

The weight 60 is formed by connecting cylindrical upper weight 62a and lower weight 62b by using a band or a coil spring, with the facing surfaces being in surface contact, between the upper plate 41a of the housing 40 and one end (with the elastic support 53) of the lever 50 such that the upper end of the upper weight 62a and the lower end of the lower weight 62b are in surface contact with the upper plate 41a and one end of the lever 50, respectively. Accordingly, when a shock force above a predetermined level is applied to at least any one of the upper and lower weights 62a, 62b, the weight bends against friction force at the joint of the upper and lower weights 62a, 62b, and between the upper end of the upper weight 62a, the lower end of the lower weight 62b and the upper plate 41a, one end of the lever 50, respectively.

The weight 60 may be a conical shape (a cone with the top cut) or a bead shape, other than the cylindrical upper and lower weights 62a, 62b.

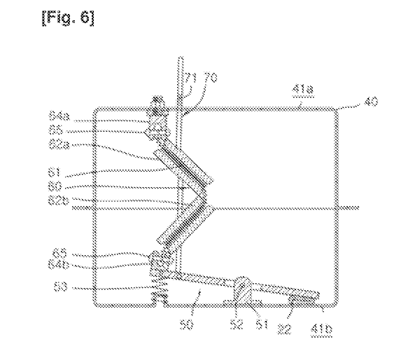

Further, since the center of weight of the upper weight 62a of the weight 60 is positioned at the lower portion, when the upper weight 62a is lighter than the lower weight 62b, as shown in FIG. 5, the upper weight 62a is prevented from restoring when secondary shock force is transmitted after the weight 60 is bent by shock force transmitted around the base 10, such that safety can be significantly improved.

Further, it is possible to make the upper end of the upper weight 62a and the lower end of the lower weight 62b in surface contact well to the upper plate 41a and one end of the lever 50, by using a coil spring as the elastic member 61 connected to the upper plate 41a of the housing 40 and one end of the lever 50, disposing bell-shaped supporting members 64a, 64b on the upper plate 41a and one end of the lever 50, and holding hooks at both ends of the coil spring by pins 65 in spaces of the supporting members 64a, 64b such that the upper end of the upper weight 62a and the lower end of the lower weight 62b are in surface contact with the portions around the spaces. Accordingly, it is possible to further prevent the upper and lower weight 62a, 62b from bending under predetermined shock force and make the connection simply and quickly.

The return rod 70 has the lower end connected to one end (connected with the lower weight 62b) of the lever 50 such that the free end (upper end) is exposed outside through the upper plate 41a, and is provided with an indicator 71 under the upper plate 41a when shock force is not transmitted to the base 10 (when the upper and lower weights 62a, 62b keep vertical). Accordingly, when the oil supply tube 22 is closed and the return rod 70 is lifted, the indicator 71 is exposed outside, such that it is possible to simply and quickly see the burning state.

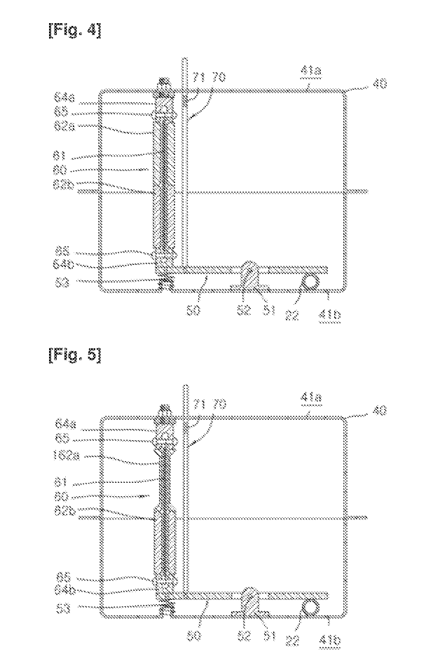

According to the present invention described above, since the joint of the upper and lower weights 62a, 62b, and the upper end of the upper weight 62a and the lower end of the lower weight 62b are in surface contact with the upper plate 41a and the lever 50 (with the bell-shaped supporting members 64a, 64b when the elastic member 61 is a coil spring), and the friction force due to the surface contact overcomes the elastic force of the elastic support 52 between one end of the lever 50 and the bottom 41b, the upper and lower weights 62a, 62b keep vertical, the lever 50 keeps horizontal, and the other end of the lever 50 does not press the oil supply tube 22, that is, the oil supply tube 22 keeps open (see FIG. 4), such that the oil (lamp oil) stored in the oil supply controller 21 is supplied to the wick tube 14.

However, when shock force above a predetermined level (e.g. an earthquake of magnitude 4 or corresponding shock force) is applied or transmitted to the outer circumference of the base 10 and the shock force is larger than the friction force, the joint of the upper and lower weights 62a, 62b slides and separates. Further, the joint of the upper and lower weights 62a, 62b are bent by the elastic restoring force of the elastic support 50 at one end of the lever 50. Therefore, the distance between the upper and lower weights 62a, 62b decreases and the other end of the lever 50 moves down, and presses and closes the oil supply tube 22, such that oil stops being supplied to the wick tube 14, thereby extinguishing the oil stove (see FIG. 6).

Meanwhile, as the other end of the lever 50 moves down and closes the oil supply tube 22, as described above, the return rod 70 connected to one end of the lever 50 is lifted, such that the indicator 71 is exposed outside the upper plate 41a, in which when the return rod 70 is pressed down in order to supply oil again to the fixed-wick 15, the lifted lever 50 moves down while contracting the elastic support 53, the weight 60 keeps vertical, the other end of the lever 50 which has closed the oil supply tube 22 is lifted and opens the oil supply tube 22 (see FIG. 4), such that oil is supplied again to the fixed-wick 15.

Although the present invention has been described with reference to the embodiment described above, it is not limited to the embodiment, and the present invention may be modified in various ways without deviating from the scope of the present invention.

1. A fire-extinguishing device for an oil stove in which a wick tube with a wick therein is disposed at one side of a base, a burning tank is connected to the upper portion of the wick tube, and the wick tube and a fuel tank are connected by an oil supply tube, the fire-extinguishing device comprising:
a hexahedral housing disposed on the base;
a lever pivotably supported by the bottom plate of the housing, with an elastic support between the bottom of one end and the bottom plate and the oil supply tube made of a heatproof material between the other end and the bottom plate;
a weight formed by connecting an upper weight with a lower weight by using an elastic member such that the facing surfaces are in surface contact between the upper plate and one end of the lever, with the upper end of the upper plate and the lower end of the lower plate in surface contact with the upper plate and one end of the lever, in order to bend when shock force above a predetermined level is transmitted to any one of the upper and lower weights; and
a return rod having the lower end connected to the lever such that the free end is exposed outside through the upper plate.

2. The fire-extinguishing device for an oil stove according to claim 1, wherein the weight is selected from a cylindrical weight, a conical weight, and a bead-shaped weight.

3. The fire-extinguishing device for an oil stove according to claim 1, wherein the upper weight is lighter than the lower weight.

4. The fire-extinguishing device for an oil stove according to claim 1, wherein a bell-shaped supporting member is disposed on the upper plate and one end of the lever, respectively and a coil spring shape elastic member with hooks at both ends is received and supported in the spaces of the supporting members such that the upper end of the upper weight and the lower end of the lower weight are surface contact to the supporting members.

5. The fire-extinguishing device for an oil stove according to claim 1, wherein the return rod is provided with an indicator, which is positioned under the upper plate when shock force is not transmitted to the base.

6. The fire-extinguishing device for an oil stove according to claim 2, wherein the upper weight is lighter than the lower weight.
